(19) United States
(12) Patent Application Publication
(10) Pub. No.: US 2009/0276760 A1
(43) Pub. Date: Nov. 5, 2009

(54) INSTRUMENTATION OF MIDP APPLICATIONS FOR ONE-DEVICE TESTING

(75) Inventors: Roman Zelov, Saint-Petersburg (RU); Alexander Glasman, St. Petersburg (RU); Mikhail A. Gorshenev, San Jose, CA (US)

Correspondence Address: BROOKS KUSHMAN P.C. / SUN / STK, 1000 TOWN CENTER, TWENTY-SECOND FLOOR, SOUTHFIELD, MI, 48075-1238, US

(73) Assignee: SUN MICROSYSTEMS, INC., Santa Clara, CA (US)

(21) Appl. No.: 12/113,151

(22) Filed: Apr. 30, 2008

(51) Int. Cl. G06F 11/36

(52) U.S. Cl. 717/127

(57) ABSTRACT

A method for testing a MIDlet application with a test application includes a step of modifying the MIDlet application to form a modified MIDlet application which allows the test application to access one or more functions, variables, or classes from the MIDlet application. The MIDlet application is then bundled with the test application to form a testable MIDlet application. The testable MIDlet application is executed on a MIDlet capable device or a MIDlet-capable device emulator and test results are collected. A system executing the method is also provided.

### BACKGROUND OF THE INVENTION

1. Field of the Invention

The present invention relates methods of testing MIDlet applications designed for embedded devices.

2. Background Art

The Java Platform, Micro Edition (“Java ME”) is an implementation of the Java platform optimized for creating applications for small microprocessor devices such as cell phones, PDAs, and other mobile devices. In particular, Java ME has become a popular development environment for creating games for these devices. The specification for the use of Java on embedded devices is the Mobile Information Device Profile (“MIDP”). Applications created by JavaME are sometimes referred to a MIDlets.

In order to run on a mobile device, the following requirements generally need to be satisfied. All MIDlet applications must be a subclass of javax.microedition.midlet.MIDlet. After appropriated testing, the MIDlet should be packaged inside a .jar file (e.g. by using the jar-tool). Prior to distribution, the .jar file is typically pre-verified by using a pre-verifier. Normally, the .jar file needs to be signed by the mobile phone's carrier.

MIDlet applications can be tested during development on a personal computer utilizing a suitable emulator. Java ME developers routinely test their applications with unit tests as part of the application's development cycle. J2MEUnit and JMUnit are particularly suitable for this type of testing. Testing is accomplished by packaging the application with the test framework and associated tests. An entry point is provided to start test execution. These testing frameworks perform the tests in a single MIDlet execution. Typically, testing results are displayed on the mobile devices screen. For many applications this protocol is quite adequate. However, J2ME applications designed for mobile devices often require a more comprehensive testing strategy.

A number of tools have been developed to provide more comprehensive needs. Such tools include JCP TCK tools, JT harness, ME Framework, Java Device Test Suite, and the like. These more modern test suites have the ability to provide a large number of tests. Therefore, the usefulness of these suites may be limited in that a mobile device cannot run an application if too many tests are incorporated therein. Moreover, it has also been observed that some test will crash the virtual machine.

Although the currently available test suites work reasonably well, there are several conspicuous problems. Automated test suites do not necessarily simplify the process of testing and debugging a Java ME application. Instead, such suites often add their own layer of complications. In some circumstances, the tests fail to provide sufficient information to identify a problem. Moreover, existing security limitations for MIDlet applications compromises the usefulness of such testing suites. Generally, the application management software is responsible for creating MIDlets. User code is not able to call a MIDlet constructor. Therefore, it is not possible to develop an application to test a MIDlet application's encapsulated functionality.

Additional problems associated with testing MIDlet applications arise because the security limitation of MIDP won't allow automatic instantiation of an application within a testing framework. Many test frame will require you to instantiate your application from a test case class but real mobile device application are instantiated from a different class such as the MIDlet class. The security limitations therefore often require a user to physically interact with the device in order to fully test functionality. Specifically, during testing the user may be required to access or implement certain features by pressing buttons or making appropriate touch screen selections in order to fully gain access to features of a MIDlet capable device.

Accordingly, there exists a need for improved methodology for testing MIDlet classes/application on small microprocessor devices.

### SUMMARY OF THE INVENTION

The present invention solves one or more problems of the prior art by providing in at least one embodiment a method of testing a MIDlet application. The method of this embodiment begins with a MIDlet application that has been previously developed. This MIDlet application is tested with a test application in accordance with the present embodiment by modifying the MIDlet application to form a modified MIDlet application. The modified MIDlet application allows the test application to access one or more functions, variables, or classes from the MIDlet application. The MIDlet application is bundled with the test application to form a testable application. The testable application is subsequently executed on a MIDlet capable device. Test results are collected from the implementation of the testable application. The method of the present embodiment are useful for testing MIDlet applications and in particular, MIDlet applications conforming to the MIDP standard.

In another embodiment of the present invention a MIDlet testing system that executes the methods set forth above is provided. The system of this embodiment includes a computer operable to modify a MIDlet application to form a modified MIDlet application. A test application is able to access one or more functions, variables, or classes from the modified MIDlet application. The MIDlet application is bundled with the test application to form a testable MIDlet application. The MIDlet testing system includes one or more interfaces so that the testable application may be transferred to a MIDlet capable device. The testable MIDlet application is executed on the MIDlet capable device and the test results collected. The MIDlet testing system includes an interface for to allow collection of the test results.

### BRIEF DESCRIPTION OF THE DRAWINGS

Exemplary embodiments of the present invention will become more fully understood from the detailed description and the accompanying drawings, wherein:

FIG. 1 is a flowchart illustrating an embodiment of the present invention for testing a MIDlet application;

FIG. 2 is a schematic illustration of a system implementing the method depicted in FIG. 1; and

FIG. 3 is a flowchart providing an example of code modification to a target MIDlet application.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

The present invention provides an on-the-fly solution for the prior art inability to fully test the functionality of a MIDlet class on a mobile device. Generally, the method of the present embodiment involves identifying a MIDlet class that is to be tested (the target MIDlet). An instance of this target MIDlet is incorporated into another application, the testing application. Each of the target MIDlet and the testing application include their own appropriated inheritance hierarchy. The MIDlet class in instantiated from the MIDlet constructor with the functions to be tested contained therein. This procedure solves the prior art instantiation problem as well as the security issues involved with externally testing a MIDlet application. The method of the present invention may be used to test a large number of mobile devices in an automated fashion.

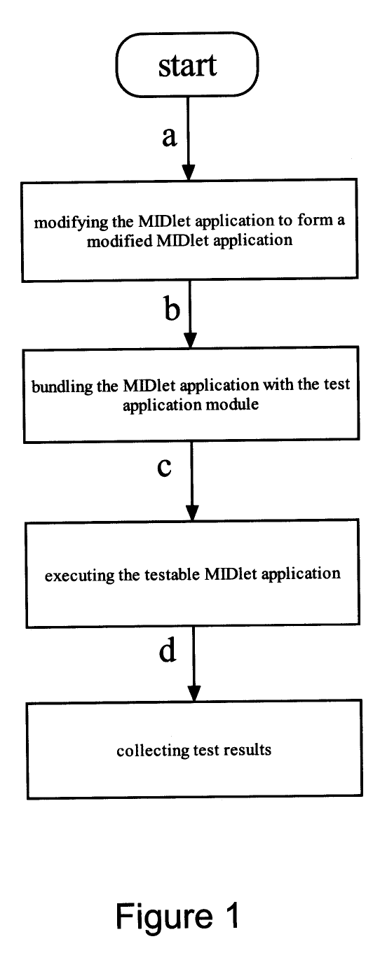

With reference to FIG. 1, a flowchart depicting a method of testing a target MIDlet application with a test application is provided. Throughout this application, the terms “application” and “class” are interchangeable since java applications are formed from collections of classes. Moreover, in this context, the test application is an application that is separate from the target MIDlet application. The purpose of the test application is to test the functionality of the target MIDlet application. In step a), the MIDlet application is modified to form a modified MIDlet application. The modified MIDlet application allows the test application to access one or more functions, variables, or classes from the MIDlet application. In particular, the test application accesses one or more functions, variables, or classes while the MIDlet application is running on a microprocessor and in particular, a microprocessor incorporated within a small device such as a cell phone, PDA, and the like. As will be set forth in more detail below, the MIDlet application is modified in a manner so that the test application is made aware of the MIDlet application. In a refinement of the present embodiment, this modification may involve registration of the test application.

Still referring to FIG. 1, the MIDlet application is bundled with the test application to form a testable MIDlet application. The testable MIDlet application includes a target MIDlet component and a testing applications component. The testable MIDlet application when executed on a microprocessor is configured so that the test application component is able to access one or more functions, variables, or classes of the target MIDlet component.

Still referring to FIG. 1, the testable MIDlet application is executed on a MIDlet capable device or a MIDlet-capable device emulator as set forth in step c). In a refinement of the present embodiment, this step is implemented with a user having to physically interact with the MIDlet-capable device. As set forth above, in some of the prior art methods for testing MIDlet applications, a user must activate various buttons or make appropriate touch screen selections in order to fully access the functionality of the MIDlet capable device. Advantageously, step c) of the present embodiment is implemented without such user intervention since the testing application may now fully access the MIDlet application's functionality. This enhanced capability is the result of the testing application including a instance of the target MIDlet application. Finally, in step d) test results are collected for subsequent evaluation. In another refinement, steps a)-d) are implemented in an automatic fashion with no or little user intervention.

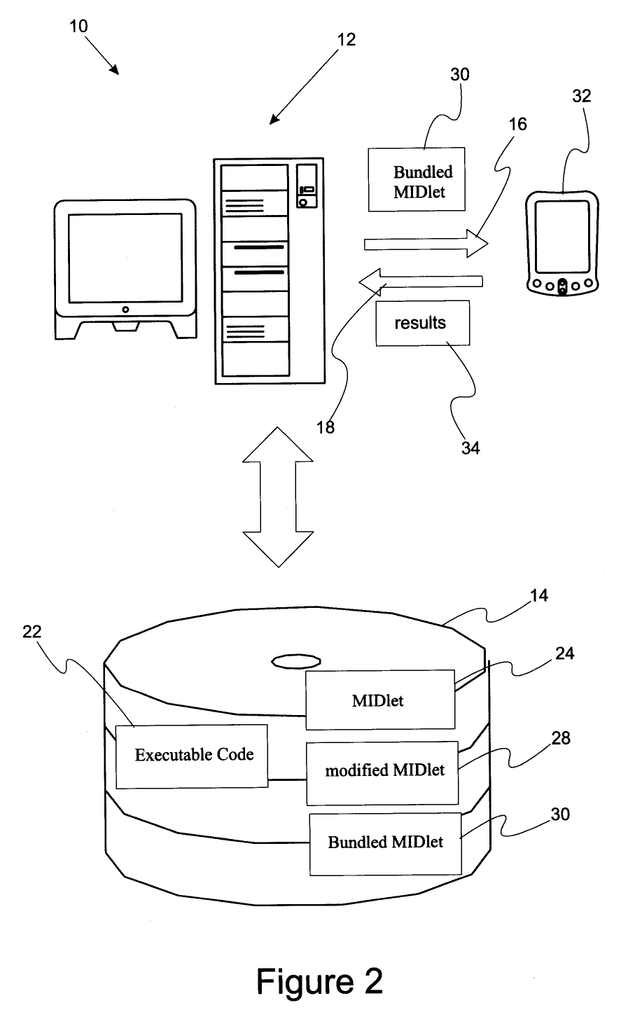

With reference to FIG. 2, a schematic illustration of a MIDlet testing system utilizing the bundle code set forth above is provided. MIDlet testing system 10 includes computer 12, digital storage medium 14, and interfaces 16, 18. Computer 12 implements one or more steps of the method set forth in FIG. 1. Examples of computer 12, include but are not limited to, desktop computers, servers, mainframe computer, microcomputers, and the like. Executable code 22 encoded on digital storage medium 14 contains executable code that allows computer 12 to perform these steps. Digital storage medium 14 includes any medium on which computer programs can be stored or encoded therein. Examples of such digital storage medium, includes but are not limited to, hard drives, tape drives, optical disks, floppy disks, DVDs, CD-ROM, flash memory, and the like.

Still referring to FIG. 2, computer 12 forms accesses MIDlet application 26 encoded on digital storage medium 14. Computer 12 modifies MIDlet application 26 as set forth above to form modified MIDlet application 28. Computer 12 is operable to bundle a test application with modified MIDlet application 28 to form bundled SampleTest/MIDlet application 30. In a refinement, the bundling is accomplished by a bundling service executed by computer 12.

Still referring to FIG. 2, bundled SampleTest/MIDlet application 30 is loaded onto MIDlet capable device 32 via interface 16. MIDlet capable device 32 is executed on MIDlet capable device 32. In refinements, a helper program is executed on MIDlet capable device 32 to assist in the loading and running of bundled SampleTest/MIDlet application 30. Such helper programs are typically provided in some of the JAVA testing tools of the prior art. It should be appreciated that MIDlet capable device 32 includes any device capable of running a MIDlet application. Examples of such devices include, but are not limited to, embedded devices, mobile phones, PDAs, set-top boxes, and vehicle telematics systems, and MIDlet-capable device emulators. In a variation of the present embodiment, bundled SampleTest/MIDlet application 30 is provided to MIDlet-capable device 32 via a provisioning service running on computer 12. Such provisioning services are typically utilized in the testing tools known in the prior art. Test results 34 derived from the execution of bundled SampleTest/MIDlet application 30 are collected by computer 12 via interface 18.

In a variation of the present invention, the modification of the MIDlet application 26 comprises injecting code into the MIDlet application to form the modified MIDlet application. In one refinement, MIDlet application 26 is modified at the source code level. In another refinement, MIDlet application 26 is modified at the bytecode level. In a refinement of this variation, the modification of MIDlet application is accomplished automatically. Therefore, if computer 12 is provided source code, an analysis program executing on computer 12 will analyze the source code and insert the appropriate functions into MIDlet application 26 source code. If computer 12 is provided bytecode for MIDlet application 26, the bytecode may be directly modified to provide the equivalent functionality to MIDlet application 26's constructors. Alternately, the bytecode can be decompiled to obtain source code which is then modified.

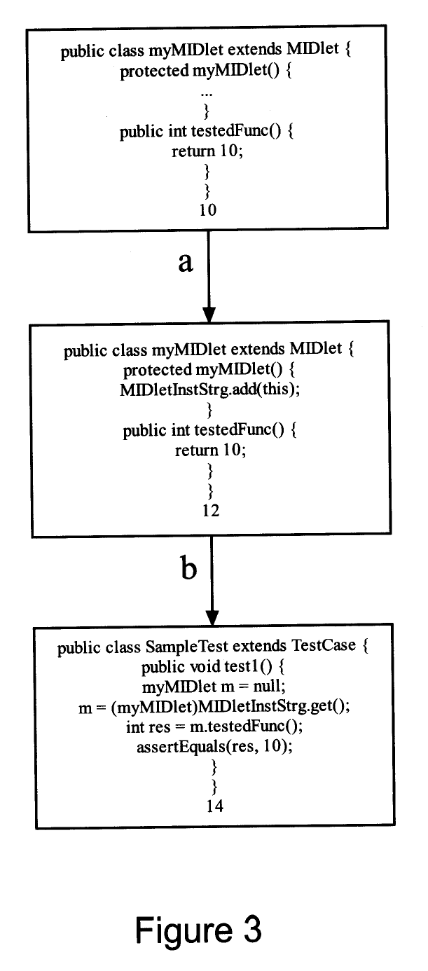

With reference to FIG. 3, a flowchart providing an example of the code modification to a target MIDlet application is provided. In this example, the class myMIDlet includes a function testedFunc( ) that is to be tested by a test application-SampleTest class. Therefore, the SampleTest class needs to gain access to the testedFunc( ) function. SampleTest includes one or more member functions such as test1( ) that perform various tests on myMIDlet. In step a), myMIDlet is modified to form a modified MIDlet application. It should be appreciated that the modified MIDlet application is itself a functioning MIDlet application in its own right.

FIG. 3 depicts a modification of a MIDlet class referred to as “myMIDlet.” Specifically, a modification is made to the myMIDlet constructor that allows SampleTest class to become aware of the component functions, variables and classes of the myMIDlet class. This modification transforms myMIDlet into a testable application. In this example, an instance of myMIDlet (an abstract class) is added to an instance of the SampleTest class in step a). This modification is accomplished by the insertion of the instruction “MIDletInstStrg.add(this)” into the myMIDlet constructor. “MIDletInstStrg.add(this)” represents an instruction that adds an instance of the present class (myMIDlet in this case) to some other object (SampleTest in this case). Therefore, within the bundled SampleTest/MIDlet application, the testable MIDlet application has access to the SampleTest class and visa versa when the bundled application is run.

Still referring to FIG. 3, the bundled SampleTest/MIDlet application is able to access the full complement of MIDlet APIs. This is in contrast to the prior art external methods of testing a Java program which do not always have such unfettered access. When the bundled SampleTest/MIDlet application is run the SampleTest application may execute and have access to the testedFunc( ). Therefore, SampleTest can execute testFunc and receive the return value. The SampleTest class includes a function test1( ) that creates an instance of myMIDlet via the instructions:

myMIDlet m=null;

m=(myMIDlet)MIDletInstStrg.get( );

The first instruction creates a null pointer to a myMIDlet object while the second instruction sets the point m to the objected added during the execution of “MIDletInstStrg.add(this)” in the myMIDlet class. Test1( ) performs the test by the following line which executes testFunc( ):

int res=m.testedFunc( )

Test1( ) is able to do this because the SampleTest class is aware of and have been provided an instance of myMIDlet. Finally, test1( ) tests to see if the returned value of testFunc( ) is 10, as it should be.

Embodiments of the present invention, require that the target MIDlet application be modified. In the example depicted in FIG. 3, this modification is achieved by modification of the source code. In an important variation, this modification is achieved without user intervention. Therefore, a server such as that in FIG. 2 performs such modification when provided a target MIDlet application and a testing application to act thereon.

The testing application utilized in the methods set forth above may be created with the JAVA testing tools known in the art. Examples of such testing tools include, but are not limited to, JCP TCK tools, JT harness, ME Framework, Java Device Test Suite, and the like.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for testing a MIDlet application with a test application, the method comprising:
a) modifying the MIDlet application to form a modified MIDlet application, the modified MIDlet application allowing the test application to access one or more functions, variables, or classes from the MIDlet application;
b) bundling the MIDlet application with the test application to form a testable MIDlet application;
c) executing the testable MIDlet application on a MIDlet capable device or a MIDlet-capable device emulator; and
d) collecting test results from step c),
wherein step c) preformed without a user physically interacting with the MIDlet capable device.

2. The method of claim 1 wherein step a) comprises injecting code into the MIDlet application to form the modified MIDlet application.

3. The method of claim 1 wherein in step a) the MIDlet application is modified at the source code level.

4. The method of claim 1 wherein in step a) the MIDlet application is modified at the bytecode level.

5. The method of claim 1 wherein the MIDlet application is modified by modifying a constructor for an instance of an abstract MIDlet class.

6. The method of claim 1 wherein the modified MIDlet application is made available to the test application by registration of the test application.

7. The method of claim 1 wherein the MIDlet capable device is an embedded device.

8. The method of claim 1 wherein the MIDlet capable device is a device selected from the group consisting of mobile phones, PDAs, set-top boxes, and vehicle telematics systems.

9. The method of claim 1 wherein step b) is performed by a bundling service.

10. The method of claim 1 wherein step c) is performed by a provisioning service.

11. A method for testing a MIDlet application with a test application, the method comprising:
a) modifying the MIDlet application to form a modified MIDlet application, the modified MIDlet application allowing the test application to access one or more functions, variables, or classes from the MIDlet application;
b) bundling the MIDlet application with the test application to form a testable MIDlet application;
c) executing the testable MIDlet application on a MIDlet capable device or a MIDlet-capable device emulator; and
d) collecting test results from step c),
wherein steps a)-d) are preformed automatically without user intervention.

12. The method of claim 11 wherein step a) comprises injecting code into the MIDlet application to form the modified MIDlet application.

13. The method of claim 11 wherein in step a) the MIDlet application is modified at the source code level.

14. The method of claim 11 wherein in step a) the MIDlet application is modified at the bytecode level.

15. The method of claim 11 wherein the MIDlet application is modified by modifying a constructor for an instance of an abstract MIDlet class.

16. A system for testing a MIDlet application with a test application, the system including a microprocessor operable to execute the following steps:
a) modifying the MIDlet application to form a modified MIDlet application, the modified MIDlet application allowing the test application to access one or more functions, variables, or classes from the MIDlet application;
b) bundling the MIDlet application with the test application to form a testable MIDlet application;
c) executing the testable MIDlet application on a MIDlet capable device or a MIDlet-capable device emulator; and
d) collecting test results from step c).

17. The system of claim 16 further comprising an interface for loading the testable MIDlet application on a MIDlet capable device.

18. The system of claim 16 further comprising an interface for collecting test results from the MIDlet capable device.

19. The system of claim 16 wherein step c) is executable with a user physically interacting with the MIDlet capable device.

20. The system of claim 16 wherein the microprocessor is operable to inject code into the MIDlet application to form the modified MIDlet application.
